(19) United States
(12) Patent Application Publication
(10) Pub. No.: US 2014/0317354 A1
(43) Pub. Date: Oct. 23, 2014

(54) ELECTRONIC DEVICE, DATA CACHING SYSTEM AND METHOD

(71) Applicant: HON HAI PRECISION INDUSTRY CO., LTD., New Taipei (TW)

(72) Inventor: HSIANG-TING CHENG, New Taipei (TW)

(73) Assignee: HON HAI PRECISION INDUSTRY CO., LTD., New Taipei (TW)

(21) Appl. No.: 14/223,965

(22) Filed: Mar. 24, 2014

(30) Foreign Application Priority Data
Apr. 23, 2013 (TW) 102114468

(51) Int. Cl. G06F 12/08

(52) U.S. Cl. CPC G06F 12/0891
USPC 711/133

(57) ABSTRACT

A data caching system applied in an electronic device is provided. The electronic device includes a processor, a cache, a main storage. Data stored in the cache is assigned with a weight value to present times that the data has been read. The data caching system includes a receiving module receiving requests for reading data from the processor. A reading module reads data according to the reading requests, and determines whether a requested data is stored in the cache. A weight value calculating module calculates the weight value, of the requested data that is stored in the cache. The weight value calculating module plus one to the weight value of the requested data when the requested data is read. If the cache is full, the data whose weight value is equal to zero is randomly selected to be cleared from the cache to release space.

### BACKGROUND

1. Technical Field

The present disclosure relates to data caching systems, and particularly to an electronic device, a data caching system and a method for caching mostly frequently used data.

2. Description of Related Art

In computer science, a cache is a component that stores data temporarily, so that the data can be accessed faster in the future. If requested data is not contained in the cache, a processor will read the requested data from a main storage and then store the requested data to the cache. However, the storage space of the cache is limited, and if the cache is full, the earliest stored data, or the least used data may be cleared from the cache to make space. In these methods, the most frequently used data may be cleared from the cache, which is inconvenient.

Therefore, what is needed is a data caching system and method to solve the above-mentioned problem.

### BRIEF DESCRIPTION OF THE DRAWINGS

Many aspects of the present disclosure should be better understood with reference to the following drawing. The components in the drawing are not necessarily drawn to scale, the emphasis instead being placed upon clearly illustrating the principles of the present device. Moreover, in the drawing, like reference numerals designate corresponding components throughout the views.

FIG. 1 is a block diagram of a data caching system applied in an electronic device, in accordance with an exemplary embodiment.

FIG. 2 is a flowchart of a data caching method, in accordance with an exemplary embodiment.

### DETAILED DESCRIPTION

Embodiments of the present disclosure are described with reference to the accompanying drawing.

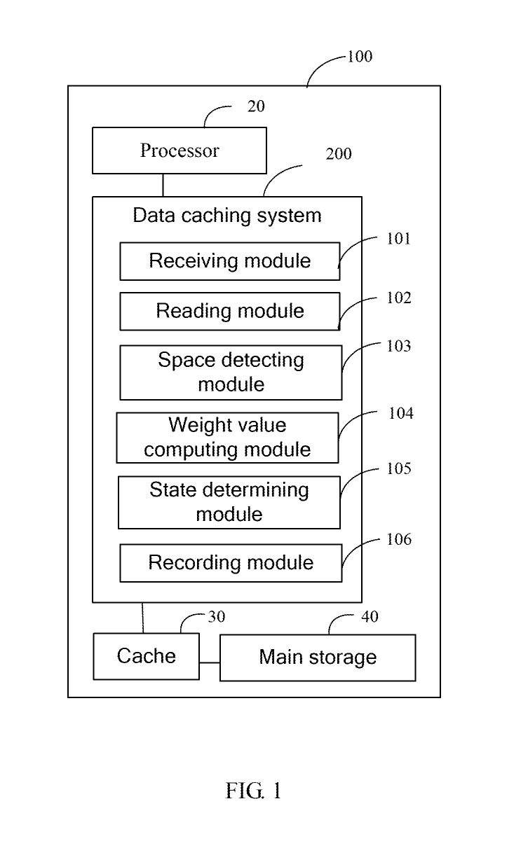

FIG. 1 shows an embodiment of an electronic device 100. The electronic device 100 includes a processor 20, a cache 30, and a main storage 40. The main storage unit 40 can be a hard disk, a compact disk, or a flash memory, for example. The processor 20 can be a central processing unit, a single chip, or a digital processor, for example. The processor 20 and the main storage 40 are connected to the cache 30.

The cache 30 is used to store data temporarily, so that future request for access to the data can be faster. Each data stored in the cache 30 is assigned a weight value to indicate the times that the data has been read. If the weight value of data is greater than 2, the data is considered in a hot state. If the weight value of data is equal to 1 but has not been written into the main storage 40, the data is considered in a first cold state. If the weight value of data is equal to 1 and has been written into the main storage 40, the data is considered in a second cold state. If the weight value of data is equal to 0, the data is considered in an available state. If data has been cleared from the cache 30 and is stored in the main storage 40, an addressing mode of the cleared data will be stored into the cache 30, and a weight value of data of the addressing mode is assigned to 1, and the data of the addressing mode is considered in a provisional state. The data of the addressing mode can be a storage address of the cleared data stored in the main storage 40. When the electronic device is initialized, the weight value of all the data in the cache 30 is set to 0, that is, all the data is in an available state. When the cache 30 is full, the data in the available state will be randomly cleared from the cache 30 to release space.

The processor 20 is used to run a data caching system 200 for caching the most frequently used data. The data caching system 100 includes a receiving module 101, a reading module 102, a space detecting module 103, a weight value calculating module 104, a state determining module 105, and a recording module 106. In this embodiment, the above mentioned modules of the data caching system 200 are collection of software instruction, and executed by the processor 20 of the electronic device 100.

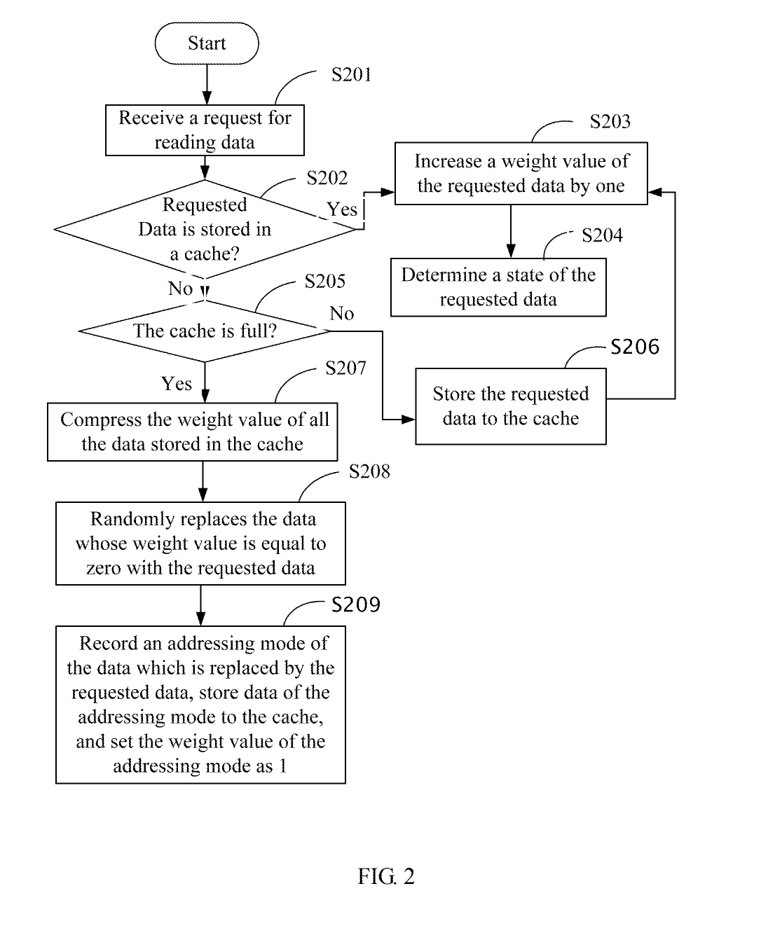

The function of the modules of the data caching system 200 will be described with reference of FIG. 2.

FIG. 2 is a flowchart of a data caching method executed by the data caching system 200.

In step S201, the receiving module 101 receives a reading request for reading data.

In step S202, the reading module 102 determines whether the requested data is stored in the cache 30. If the requested data is stored in the cache 30, the procedure goes to step S203; if the requested data is not stored in the cache 30, the procedure goes to step S205.

In step S203, the weight value calculating module 104 increases the weight value of the requested data by one when the requested data is read by the processor 20.

In step S204, the state determining module 105 determines a state of the requested data read by the processor 20. In detail, if the requested data is in the hot state before being read, the weight value of the requested data remains greater than 2 after the requested data is read, the state determining module 105 determines that the requested data remains in the hot state. If the requested data is in the first cold state before being read, the weight value of the requested data is equal to 2 after the requested data is read, and the state determining module 105 determines that the requested data is changed to the hot state. If the requested data is in the second cold state before being read, the weight value of the requested data is equal to 2 after the requested data is read, and the state determining module 105 determines that the requested data is changed to the hot state. If the requested data is in the available state before being read, the weight value of the requested data is equal to 1 after the requested data is read, and the state determining module 105 determines that the requested data is changed to the first cold state if the requested data is not written into the main storage 40, and determines that the requested data is changed to the second cold state if the read data is written into the main storage 40. If the requested data is not stored in the cache 30, but the addressing mode of the requested data is stored in the cache 30 and the weight value of the addressing mode is equal to 1, the state determining module 105 determines whether available data exists in the cache 30. If there is available data existing in the cache 30, the state determining module 105 randomly replaces the available data with the requested data, and determines the weight value of the requested data as 2, and determines the state of the requested data is changed to the hot state, if there is no available data exist in the cache 30, the state determining module 105 compresses the weight value of all the data stored in the cache 30, and re-determines the state of all of the data stored in the cache 30 according to the compressed weight value. Wherein compress the weight value means that reduce the weight value in with a certain proportion. In this embodiment, the state determining module 105 compresses the weight value as follows: the weight value is divided by 2 and then is rounded up.

In step S205, the space detecting module 103 determines whether the cache 30 is full; if the cache 30 is not full, the procedure goes to step S206; if the cache 30 is full, the procedure goes to step S207.

In step S206, the reading module 102 stores the requested data read by the processor 20 into the cache 30, and then the procedure goes to step S204.

In step S207, the state determining module compresses the weight value of all the data stored in the cache 30, and re-determines the state of all of the data stored in the cache 30. In detail, if the data is in a hot state before the weight value of the data is compressed, and the weight value of the data remains greater than or equal to 2 after being compressed, the state determining module 105 determines that the data is still in the hot state. If the data is in a hot state and is not written into the main storage 40 before the weight value of the data is compressed, and the weight value of the data equals 1 after being compressed, the state determining module 105 determines that the data is in the first cold state if. If the data is in a hot state before the weight value of the data is compressed, and the weight value of the data equals 1 after being compressed, the state determining module 105 determines that the data is in the second cold state if the data is written into the main storage 40. If one data is in a first cold state before the weight value of the data is compressed, and the weight value of the data equals to 0 after being compressed, the state determining module 105 stores the data whose weight value is compressed into the main storage 40 and determines that the data is in the available state. If the data is in a second cold state before the weight value is compressed, the weight value equals to 0 after being compressed, the state determining module 105 determines that the data is in the available state. If the data of addressing mode stored in the cache 30 is in a provisional state before the weight value is compressed, the weight value of the data of the addressing mode equals to 0 after being compressed, the state determining module 105 determines that the data of the addressing mode is in the available state. In addition, the state determining module 105 stores the data corresponding to the first cold state into the main storage 40 if the data is not stored in the main storage 40 and change the state to the second cold state after storing the data into main storage 40.

In step S208, the reading module 102 randomly replaces the data in the available state with the requested data read by the processor 20 from the main storage 40.

In step S209, the recording module 106 records the addressing mode of the data, which is replaced by the read data, stores the data of the addressing mode to the cache 30, and sets the weight value of the addressing mode as 1, and the data of the addressing mode is in the provisional state.

Although the present disclosure has been specifically described on the basis of exemplary embodiments thereof, the disclosure is not to be construed as being limited thereto. Various changes or modifications may be made to the embodiments without departing from the scope and spirit of the disclosure.

What is claimed is:

1. An electronic device comprising:
a processor;
a cache configured to store data temporarily, each data stored in the cache being assigned with a weight value to indicate times that the data has been read by the processor; and
a main storage;
the processor comprising:
a receiving module configured to receive reading requests;
a reading module configured to read data according to the reading requests, and determine whether a requested data being stored in the cache; and
a weight value calculating module configured to increase the weight value of the requested data by one when the requested data is stored in the cache, and randomly select the data whose weight value is equal to zero and clear the selected data away from the cache to release space when the cache is full.

2. The electronic device as described in claim 1, wherein the processor further comprises a state determining module to determine a state of the data stored in the cache, if the weight value of data is greater than or equal to 2, the data is considered in a hot state; if the weight value of data is equal to 1 and the data has not been written into the main storage, the data is considered in a first cold state; if the weight value of data is equal to 1 and the data has been written into the main storage, the data is considered in a second cold state; if the weight value of data is equal to 0, the data is considered in an available state; if one data is not stored in the cache, but an addressing mode of the data is stored in the cache, and the weight value data of the addressing mode is assigned to 1, and the data of the addressing mode is considered in a provisional state.

3. The electronic device as described in claim 2, wherein the state determining module determines the state of the data stored in the cache according to the weight value of the requested data after the weight value is increased by one, if the requested data is in the hot state before being read, the weight value of the requested data remains greater than 2 after the requested data is read, and the state determining module determines that the requested data remains in the hot state; if the requested data is in the first cold state before being read, the weight value of the requested data is equal to 2 after the requested data is read, and the state determining module determines that the requested data is changed to the hot state; if the requested data is in the second cold state before being read, the weight value of the requested data is equal to 2 after the requested data is read, and the state determining module determines that the requested data is changed to the hot state; if the requested data is in the available state before being read, the weight value of the requested data is equal to 1 after the requested data is read, and the state determining module determines that the requested data is changed to the first cold state if the requested data is not written into the main storage, and determines that the requested data is changed to the second cold state if the read data is written into the main storage; if the requested data is not stored in the cache, but the addressing mode of the requested data is stored in the cache and the weight value of the addressing mode is equal to 1, the state determining module determines whether available data is exist in the cache, if there is available data exist in the cache, the state determining module randomly replaces the available data with the requested data, and determines the weight value of the requested data as 2, and determines the state of the requested data is changed to the hot state, if there is no available data exist in the cache, the state determining module compresses the weight value of all the data stored in the cache, and re-determines the state of all the data stored in the cache according to the compressed weight value, wherein the weight value is divided by 2 and then rounded up to be compressed.

4. The electronic device as described in claim 3, wherein if the data is at a hot state before the weight value of the data is compressed, and the weight value of the data remains greater than or equal to 2 after being compressed, the state determining module determines that the data is still in the hot state; if the data is at a hot state and is not written to the main storage before the weight value of the data is compressed, and the weight value of the data equals to 1 after being compressed, the state determining module determines that the data is in the first cold state; if the data is at a hot state and is written to the main storage before the weight value of the data is compressed, and the weight value of the data equals to 1 after being compressed, the state determining module determines that the data is in the second cold state; if the data is at a first cold state before the weight value of the data is compressed, and the weight value of the data equals to 0 after being compressed, the state determining module stores the data into the main storage and determines that the data is in the available state; if the data is in a second cold state before the weight value is compressed, the weight value equals to 0 after being compressed, the state determining module determines that the data is in the available state; if the data of addressing mode stored in the cache is in a provisional state before the weight value is compressed, the weight value of the data of the addressing mode equals to 0 after being compressed, the state determining module determines that the data of the addressing mode is in the available state, the state determining module further stores the data corresponding to the first cold state into the main storage if the data corresponding to the addressing mode is not stored in the main storage, and change the state of the data to the second cold state after storing the data to the main storage.

5. The electronic device as described in claim 1, wherein if the cache is not full and the requested data is not stored in the cache, the reading module stores the requested data to the cache; if the requested data is not stored in the cache and the cache is full, the reading module randomly replaces the data whose weight value is equal to 0 with the requested data.

6. The electronic device as described in claim 4, wherein the processor further comprises a recording module to record an addressing mode of the data which is replaced by the requested data, store the data of the addressing mode to the cache, and set the weight value of the addressing mode as 1, and the data of the addressing mode is in the provisional state.

7. A data caching system applied in an electronic device, the electronic device comprises a cache, a main storage, and at least one processor, data stored in the cache being assigned with a weight value to present times that the data has been read, the data caching system comprising:
a plurality of modules which are collection of instructions executed by one or more processor of the electronic device, the modules comprising:
a receiving module configured to receive reading requests from the processor;
a reading module configured to read data according to the reading requests, and determine whether a requested data being stored in the cache; and
a weight value calculating module configured to increase the weight value of the requested data by one when the requested data being stored in the cache; and randomly select the data whose weight value is equal to zero and clear the selected data away from the cache to release space when the cache is full.

8. The data caching system as described in claim 7, wherein the data caching system further comprises a state determining module to determine a state of the data stored in the cache, if the weight value of the data is greater than or equal to 2, the data is considered in a hot state; if the weight value of the data is equal to 1 and has not been written into the main storage, the data is considered in a first cold state; if the weight value of the data is equal to 1 and has been written into the main storage, the data is considered in a second cold state; if the weight value of a data is equal to 0, the data is considered in an available state; if a data is not stored in the cache, but an addressing mode of the data is stored in the cache, and data of the addressing mode is assigned with a weight value of 1, the data of the addressing mode is considered in a provisional state.

9. The data caching system as described in claim 8, wherein the state determining module determines the state of the data stored in the cache according to the weight value of the requested data after the weight value is increased by one, if the requested data is in the hot state before being read, the weight value of the requested data remains greater than 2 after the requested data is read, and the state determining module determines that the requested data remains in the hot state; if the requested data is in the first cold state before being read, the weight value of the requested data is equal to 2 after the requested data is read, and the state determining module determines that the requested data is changed to the hot state; if the requested data is in the second cold state before being read, the weight value of the requested data is equal to 2 after the requested data is read, and the state determining module determines that the requested data is changed to the hot state; if the requested data is in the available state before being read, the weight value of the requested data is equal to 1 after the requested data is read, and the state determining module determines that the requested data is changed to the first cold state if the requested data is not written into the main storage, and determines that the requested data is changed to the second cold state if the read data is written into the main storage; if the requested data is not stored in the cache, but the addressing mode of the requested data is stored in the cache and the weight value of the addressing mode is equal to 1, the state determining module determines whether available data is exist in the cache, if there is available data exist in the cache, the state determining module randomly replaces the available data with the requested data, and determines the weight value of the requested data as 2, and determines the state of the requested data is changed to the hot state, if there is no available data exist in the cache, the state determining module compresses the weight value of all the data stored in the cache, and re-determines the state of all the data stored in the cache according to the compressed weight value, wherein the weight value is divided by 2 and then rounded up to be compressed.

10. The data caching system as described in claim 9, wherein if the data is at a hot state before the weight value of the data is compressed, and the weight value of the data remains greater than or equal to 2 after being compressed, the state determining module determines that the data is still in the hot state; if the data is at a hot state and is not written to the main storage before the weight value of the data is compressed, and the weight value of the data equals to 1 after being compressed, the state determining module determines that the data is in the first cold state; if the data is at a hot state and is written to the main storage before the weight value of the data is compressed, and the weight value of the data equals to 1 after being compressed, the state determining module determines that the data is in the second cold state; if the data is at a first cold state before the weight value of the data is compressed, and the weight value of the data equals to 0 after being compressed, the state determining module stores the data into the main storage and determines that the data is in the available state; if the data is at a second cold state before the weight value is compressed, the weight value equals to 0 after being compressed, the state determining module determines that the data is in the available state; if the data of addressing mode stored in the cache is at a provisional state before the weight value is compressed, the weight value of the data of the addressing mode equals to 0 after being compressed, the state determining module determines that the data of the addressing mode is in the available state, the state determining module further stores the data corresponding to the first cold state into the main storage if the data corresponding to the addressing mode is not stored in the main storage, and change the state of the data to the second cold state after storing the data to the main storage.

11. The data caching system as described in claim 7, wherein if the cache is not full and the requested data is not stored in the cache, the reading module stores the requested data to the cache; if the requested data is not stored in the cache and the cache is full, the reading module randomly replaces the data whose weight value is equal to 0 with the requested data.

12. The data caching system as described in claim 10, wherein the modules further comprises a recording module to record an addressing mode of the data which is replaced by the requested data, store the data of the addressing mode to the cache, and set the weight value of the addressing mode as 1, and the data of the addressing mode is in the provisional state.

13. A data caching system applied in an electronic device, the electronic device comprises a processor, a cache, and a main storage, data stored in the cache being assigned with a weight value to present times that the data has been read, the data caching system comprising:
receiving reading requests from the processor;
reading data according to the reading requests, and determining a requested data being stored in the cache; and
increasing the weight value of the requested data by one if the requested data being stored in the cache, wherein when the cache is full, and randomly selecting the data whose weight value is equal to zero and clearing the selected data away from the cache to release space when the cache is full.

14. The data caching method as described in claim 13, wherein the method further comprising:
determining a state of the data stored in the cache, wherein if the weight value of the data is greater than or equal to 2, the data is considered in a hot state; if the weight value of the data is equal to 1 and the data has not been written into the main storage, the data is considered in a first cold state; if the weight value of the data is equal to 1 and the data has been written into the main storage, the data is considered in a second cold state; if the weight value of a data is equal to 0, the data is considered in an available state; if a data is not stored in the cache, but an addressing mode of the data is stored in the cache, and data of the addressing mode is assigned with a weight value of 1, the data of the addressing mode is considered in a provisional state.

15. The data caching method as described in claim 14, wherein the state of the requested data is determined by the weight value of the data after the weight value of the requested data is increased by one; if the requested data is in the hot state before being read, the weight value of the requested data remains greater than 2 after the requested data is read, and the requested data is determined in the hot state; if the requested data is in the first cold state before being read, the weight value of the requested data is equal to 2 after the requested data is read, the requested data is determined to changed to the hot state; if the requested data is in the second cold state before being read, the weight value of the requested data is equal to 2 after the requested data is read, and the requested data is determined to change to the hot state; if the requested data is in the available state before being read, the weight value of the requested data is equal to 1 after the requested data is read, and the requested data is determined to changed to the first cold state if the requested data is not written into the main storage, and determines that the requested data is changed to the second cold state if the read data is written into the main storage; if the requested data is not stored in the cache, but the addressing mode of the requested data is stored in the cache and the weight value of the addressing mode is equal to 1, determines whether available data is exist in the cache, if there is available data exist in the cache, randomly replaces the available data with the requested data, and determines the weight value of the requested data as 2, and determines the state of the requested data is changed to the hot state, if there is no available data exist in the cache, compressing the weight value of all the data stored in the cache, and re-determining the state of all the data stored in the cache according to the compressed weight value, wherein the weight value is divided by 2 and then rounded up to be compressed.

16. The data caching method as described in claim 15, wherein if the data is at a hot state before the weight value of the data is compressed, and the weight value of the data remains greater than or equal to 2 after being compressed, determining that the data is still in the hot state; if the data is at a hot state and is not written to the main storage before the weight value of the data is compressed, and the weight value of the data equals to 1 after being compressed, the state determining module determines that the data is in the first cold state; if the data is at a hot state and is written to the main storage before the weight value of the data is compressed, and the weight value of the data equals to 1 after being compressed, the state determining module determines that the data is in the second cold state; if the data is at a first cold state before the weight value of the data is compressed, and the weight value of the data equals to 0 after being compressed, storing the data into the main storage and determines that the data is in the available state; if the data is at a second cold state before the weight value is compressed, the weight value equals to 0 after being compressed, determining that the data is in the available state; if the data of addressing mode stored in the cache is at a provisional state before the weight value is compressed, the weight value of the data of the addressing mode equals to 0 after being compressed, determining that the data of the addressing mode is in the available state, the state determining module further stores the data corresponding to the first cold state into the main storage if the data corresponding to the addressing mode is not stored in the main storage, and change the state of the data to the second cold state after storing the data to the main storage.

17. The data caching method as described in 13, wherein the method further comprising: if the cache is not full and the requested data is not stored in the cache, storing the requested data to the cache; if the requested data is not stored in the cache and the cache is full, randomly replacing the data whose weight value is equal to 0 with the requested data.

18. The data caching method as described in claim 13, wherein the method further comprising: recording an addressing mode of the data which is replaced by the requested data, storing the data of the addressing mode to the cache, and setting the weight value of the addressing mode as 1, and the data of the addressing mode is in the provisional state
